(19) United States
(12) Patent Application Publication
(10) Pub. No.: US 2008/0191572 A1
(43) Pub. Date: Aug. 14, 2008

(54) Skewed magnetic torque coupling systems and methods thereof

(75) Inventor: James B. Roozee, Crystal Lake, IL (US)

Correspondence Address: NIXON PEABODY LLP - PATENT GROUP, 1100 CLINTON SQUARE, ROCHESTER, NY, 14604, US

(73) Assignee: Arnold Magnetic Technologies, Rochester, NY (US)

(21) Appl. No.: 11/704,738

(22) Filed: Feb. 9, 2007

(51) Int. Cl. F16D 27/00

(52) U.S. Cl. 310/103; 29/426.5; 29/428

(57) ABSTRACT

Torque coupling systems and methods thereof include concentric cylindrical inner and outer rotor systems. The inner rotor system extends at least generally along the axis of the cylinder and comprises two or more inner magnets which have equal numbers of alternating positive poles and negative poles. The outer rotor system is seated over at least a portion of the inner rotor system and comprises two or more outer magnets which have equal numbers of alternating positive poles and negative poles. In the resting or stable position, the inner positive pole magnets are adjacent to the outer negative pole magnets. At least one of the two or more inner magnets and at least one of the two or more outer magnets have edges which are skewed around the first axis. The movement of the outer rotor system with respect to the inner rotor system applies a torque to a device coupled to the inner rotor system.

### FIELD OF THE INVENTION

The present invention generally relates to torque coupling systems and, more particularly, to skewed magnet torque coupling systems and methods thereof.

### BACKGROUND

In many applications torque couplings and torque limiters are used to apply a torque and ensure that the force is released once a maximum value has been obtained. Generally, the application of the torque and its release are sudden causing a rapid increase in applied force and a rapid decline in force to a zero-torque condition. The abruptness of the application and release can create shock to the apparatus to which the torque is applied. When the apparatus is sensitive or fragile the shock can cause damage or distress. To improve control when applying torque to a device, screw, bolt, or drive assembly, the invention employs a magnetic coupling containing skewed drive magnets. This allows a gradual build up of the coupling force and a gradual decline in force after the peak load point has been reached.

### SUMMARY

A torque coupling system in accordance with embodiments of the present invention includes concentric cylindrical inner and outer rotor systems. The inner rotor system extends at least generally along the axis of the cylinder and comprises two or more inner magnets which have equal numbers of alternating positive poles and negative poles. The outer rotor system is seated over at least a portion of the inner rotor system and comprises two or more outer magnets which have equal numbers of alternating positive poles and negative poles. In the resting or stable position, the inner positive pole magnets are adjacent to the outer negative pole magnets. At least one of the two or more inner magnets and at least one of the two or more outer magnets have edges which are skewed around the first axis. The movement of the outer rotor system with respect to the inner rotor system applies a torque to a device coupled to the inner rotor system.

A method of making a torque coupling system in accordance with other embodiments of the present invention includes providing concentric cylindrical inner and outer rotor systems. The inner rotor system comprises two or more inner magnets which have equal numbers of alternating positive poles and negative poles. The outer rotor system comprises two or more outer magnets which have equal numbers of alternating positive poles and negative poles. At least one of the two or more inner magnets and at least one of the two or more outer magnets have edges which are skewed around the first axis. The movement of the outer rotor system with respect to the inner rotor system applies a torque to a device detachably coupled to the inner rotor system.

A method of applying torque to a device in accordance with other embodiments of the present invention includes detachably coupling a cylindrical inner rotor system to a device and rotating a concentric cylindrical outer rotor system that is seated over the inner rotor system to apply torque to the device detachably coupled to the inner rotor system. The inner rotor system extends at least generally along the axis of the cylinder and comprises two or more inner magnets which have equal numbers of alternating positive poles and negative poles. The outer rotor system is seated over at least a portion of the inner rotor system and comprises two or more outer magnets which have equal numbers of alternating positive poles and negative poles. At least one of the two or more inner magnets and at least one of the two or more outer magnets have edges which are skewed around the first axis.

A torque coupling device in accordance with embodiments of the present invention includes an inner magnet assembly and an outer magnet assembly, although the device could comprise other numbers and types of elements. The inner magnet assembly comprises magnet segments arranged in a north/south pole manner and adhesively bonded around a flux carrying steel shaft, although these magnet segments could be arranged in other manners and orientations and could be secured in other ways. The outer magnet assembly also uses magnet segments arranged in a north/south manner and adhesively bonded around the inner diameter of a flux carrying hollow cylinder, although these magnet segments also could be arranged in other manners and orientations and could be secured in other ways. When the inner magnet assembly is placed into the outer magnet assembly the segments all align north to south to create a magnetically neutral position. By applying an external torque force to the assembly (to the shaft or to the cylinder) by way of flux coupling the ‘driven’ assembly will move the one of the inner and outer magnet assemblies that is the “slave” assembly. If the “slave” assembly has resistance the flux coupling will allow slip and the driven magnet segments will step to the next pair of magnet segments. By tuning the number of magnetic poles in the device divergent torques can be produced. Accordingly, one of the advantages of the present invention is the ability to tune the torque rollover and soften and reduce shock to the device being torque. By skewing the poles of the magnet segments, the torque build-up and decline can be eased. Varying the slew angle or north/south interface on the segments enables the torque control to be controlled, although an angle is not the only method of producing this affect. By way of example only, multiple angles or curves can be used to soften the transition from pole to pole interface. This is true for all magnetic materials whether they are sintered or bonded products.

The present invention provides a torque coupling system that has better control over changes in the output torque making it easier to use. By skewing the edges of the magnets with the present invention, the torque application and release is made to be more gradual resulting in greater control.

### BRIEF DESCRIPTION OF THE DRAWINGS

FIG. 1A is a side perspective view of a torque coupling system which has sets of magnets with opposite polarities in substantial alignment;

FIG. 1B is a side-cross-sectional view of the torque coupling system shown in FIG. 1A taken along lines 1B-1B;

FIG. 2 is a perspective view of a shaft for the torque coupling system;

FIG. 3A is a perspective view of sets of magnets for an inner rotor system on the shaft;

FIG. 3B is a side cross-sectional view of sets of magnets for the inner rotor system on the shaft;

FIG. 4A is a side perspective view of a housing and outer rotor system for the wrench;

FIG. 4B is a side cross-sectional view of the housing and the outer rotor system;

FIG. 4C is another side cross-sectional view of the housing and the outer rotor system taken along lines 4C-4C in FIG. 4B; and

FIG. 5 is a perspective view of an outer magnet assembly showing skewed system.

### DETAILED DESCRIPTION

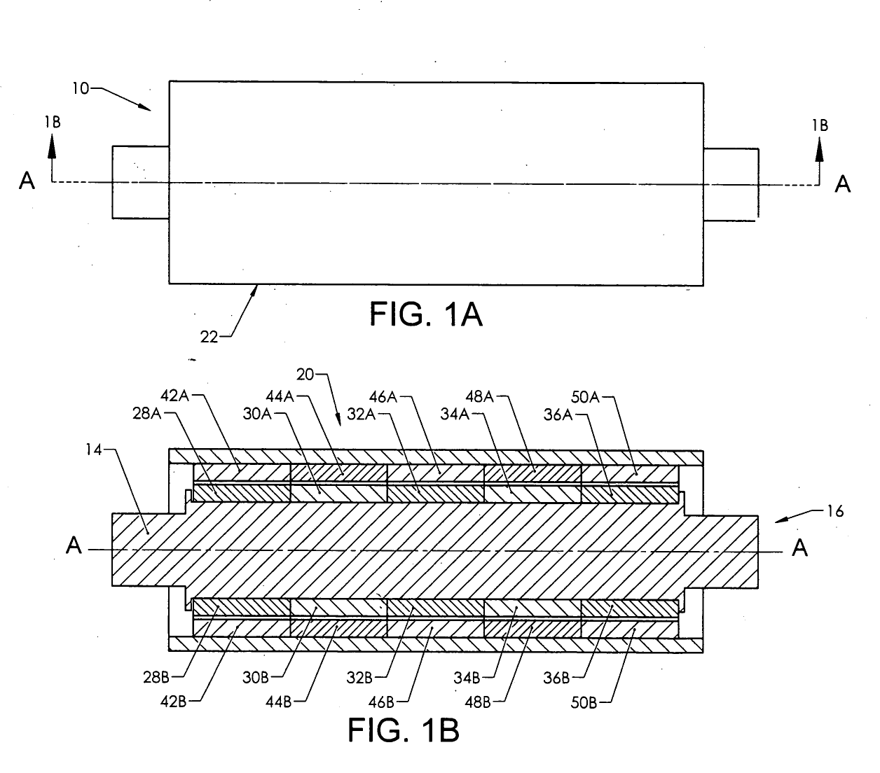

A skewed magnetic torque coupling system 10 in accordance with embodiments of the present invention is illustrated in FIGS. 1A-4C. The torque coupling system 10 includes an inner rotor system 14 with a shaft 18, an outer rotor system 20, and a housing 22, although the torque coupling system can comprise other numbers and types of components in other configurations. The skewed magnetic torque coupling system can be used in a wide variety of different types of devices and applications. The present invention provides a number of advantages including providing a skewed magnetic torque coupling system that has a more gradual torque roll over with the same torque output.

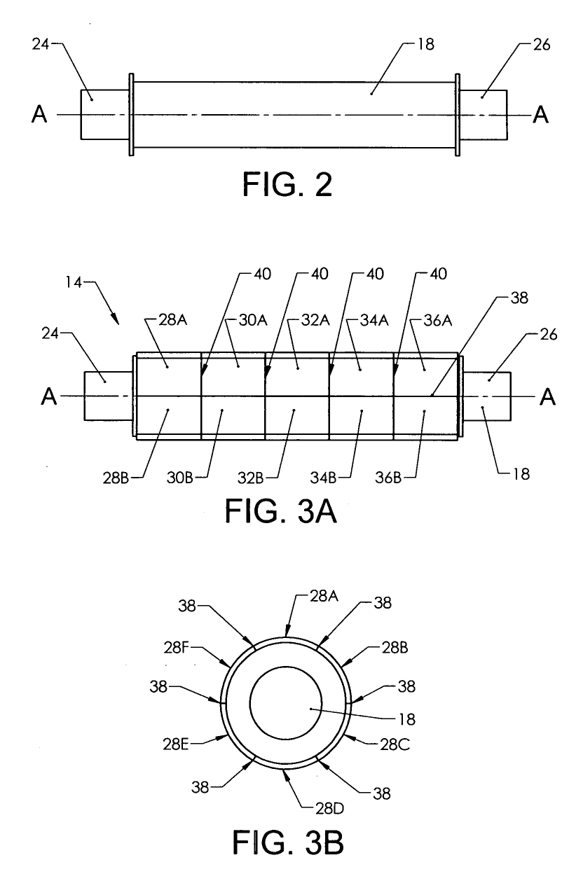

Referring to FIG. 2, the inner rotor system 14 includes the shaft 18 which has a pair of opposing ends 24 and 26, although the inner rotor system 14 could have other types and numbers of components in other configurations. The shaft 18 is made of 400 Series magnetic stainless steel, although other types of magnetic material can be used, so that it can form and is part of the magnetic circuit and adds to the output of torque. Ends 24 and 26 each have a connection point for detachably engaging with a device to apply the torque, although other manners for connecting the inner rotor system 14 to apply torque can be used.

Referring to FIGS. 1B, 3A, and 3B, the inner rotor system 14 also includes five sets each with six, equally spaced magnets which are alternating positive poles and negative poles, although other numbers of sets with other even numbers of magnets, spacing arrangements and configurations could be used. The six magnets 28A-28F of the first set are illustrated, however simply for ease of illustration only two of the six magnets 30A-30B, 32A-32B, 34A-34B, and 36A-36B in the other four sets, which are like magnets 28A-28F, are shown. Each of the magnets in the five sets for the inner rotor system 14 described above is secured to the shaft 18 with an adhesive, although other manners of securing each of the magnets to the shaft 18 could be used.

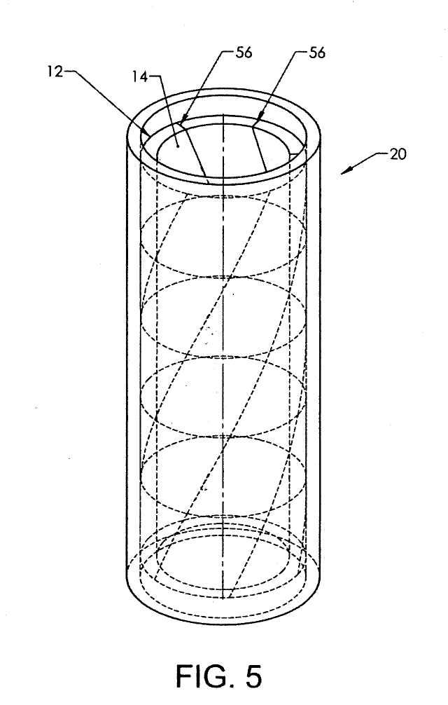

Within each of the five sets of six magnets for the inner rotor system 14, each of the magnets in these sets are separated along lines 38 that extend between the sets and which are substantially parallel to axis A-A which extends through the shaft 18 of the inner rotor system 14, although the magnets in one or more of the sets of magnets could be separated along other lines with respect to the axis A-A, such as along lines which are skewed with respect to the axis A-A (see FIG. 5 by way of example only). By skewing the lines which separate the magnets in each of the sets of magnets, the torque release is made more gradual to minimize the shock down the shaft 18. Additionally, each of the magnets in these sets for the inner rotor system 14 are separated from each other along lines 40 which are substantially perpendicular to axis A-A, although two or more of the sets of the magnets for the inner rotor system 14 could be separated along other lines with respect to the axis A-A. Although one pattern for the skewed lines which separate the magnets in each of the sets of magnets is shown, the skewed lines can have a variety of different configurations and patterns, such as with different curved, stepped, and/or straight patterns.

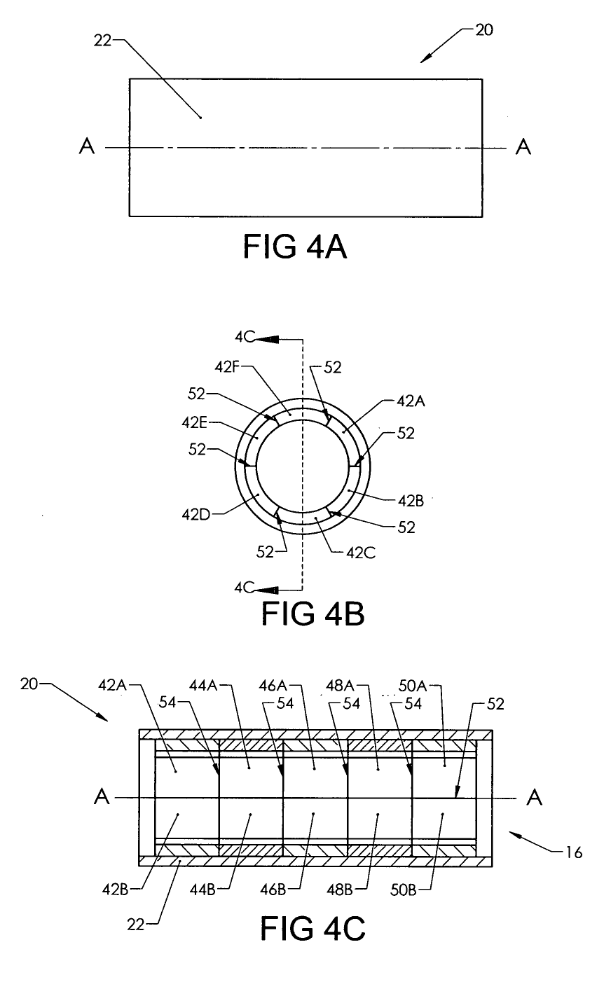

Referring to FIGS. 4A-4C and 5, the outer rotor system 20 provides a passage 16 in which the inner rotor system 14 is seated. The outer rotor system 20 includes five sets of six equally spaced magnets which are alternating positive poles and negative poles, although other numbers of sets with other even numbers of magnets, spacing arrangements, and configurations could be used. The six magnets 42A-42F of the first set are illustrated, however simply for ease of illustration only two of the six magnets 44A-44B, 46A-46B, 48A-48B, and 50A-50B in the other four sets, which are like the magnets 42A-42F, are shown. Each of the magnets in each of these sets for the outer rotor 22 system described above is secured to an inner surface of the housing 22 with an adhesive, although other manners of securing each of the magnets in each of the sets to the housing 22 and other manners for positioning the sets of magnets for the outer rotor system 20 about the inner rotor system 14 can be used.

Within each of the sets of magnets for the outer rotor system 20 described above, each of the magnets in these sets are separated along lines 52 that extend between the sets and which are substantially parallel to axis A-A which extends through the shaft 18 of the inner rotor system 14, although the magnets in one or more of the sets of magnets for the outer rotor system 20, could be separated along other lines with respect to the axis A-A, such as along lines 56 which are skewed with respect to the axis A-A as shown and described with respect to the skewed magnetic, torque coupling system 12 shown in FIG. 5. By skewing the lines which separate the magnets in each of the sets of magnets for the outer rotor system 20, the torque build up and release is made more gradual to minimize rotational shock. Additionally, each of the sets of magnets for the outer rotor system 20 are separated from each other along lines 54 which are substantially perpendicular to axis A-A, although two or more of the sets of magnets for the outer rotor system 20 could be separated along other lines with respect to the axis A-A. Although one pattern for the skewed lines which separate these magnets in each of the sets of magnets is shown, the skewed lines can have a variety of different configurations and patterns, such as with different curved, stepped, and/or straight patterns.

The operation of the device 10 with the torque coupling system will now be described with reference to FIGS. 2-4C. The outer rotor system 20 is rotated with respect to the inner rotor system 14 to generate torque which can be transmitted out via the shaft 18. As each of the magnets in the sets of magnets in the inner rotor system 14 is rotated towards one of the lines 52 separating the magnets in the sets of magnets in the outer rotor system 20, the applied torque increases to a maximum at the lines 52 and then is released once the lines 52 are passed. With the use of these skewed sets of magnets, the present invention is able to provide a much more gradual torque build up and release that provides the operator with greater control and less shock.

The operation of the device 12 is the same as the operation of the device 10, except as described below. With the skew to the lines 56 which separate the magnets in the sets of magnets in the inner rotor system 14, the torque build up and release with device 12 is more gradual to minimize the shock on the shaft 18.

Accordingly, as described above the present invention provides a torque coupling system that has better control over the output torque. By skewing the lines of separation between the magnets with the present invention, the torque build up and release is made to be more gradual resulting in greater control.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A torque coupling system comprising:
an inner rotor system that extends at least generally along a first axis, the inner rotor system comprises two or more inner magnets which have alternating positive poles and negative poles; and
an outer rotor system is seated over at least a portion of the inner rotor system, the outer rotor system comprises two or more outer magnets which have alternating positive poles and negative poles, wherein at least one of the two or more inner magnets and the two or more outer magnets are separated from each other along lines which are skewed with respect to the first axis and wherein movement of the outer rotor system with respect to the inner rotor system applies a torque to a device coupled to the inner rotor system.

2. The system as set forth in claim 1 wherein the inner rotor system further comprises a shaft which extends along the first axis and has a connection point adjacent one end used for detachably engaging with the device, the two or more inner magnets are connected about at least a portion of the shaft.

3. The system as set forth in claim 1 wherein the two or more outer magnets are separated from each other along the lines which are substantially parallel with respect to the first axis.

4. The system as set forth in claim 1 wherein the lines which separate the two or more outer magnets are skewed with respect to the first axis.

5. The system as set forth in claim 1 wherein the inner rotor system comprises two or more sets of the inner magnets which are spaced along the first axis and wherein the outer rotor system comprises two or more sets of the outer magnets which are spaced along the first axis.

6. The system as set forth in claim 5 wherein each of the sets of inner magnets is substantially in alignment with one of the sets of outer magnets.

7. The system as set forth in claim 5 wherein each of the sets of inner magnets is out of alignment with one of the sets of outer magnets.

8. The system as set forth in claim 1 further comprising a housing which is extends around at least a portion of the outer rotor system.

9. A method of making a torque coupling system, the method comprising:
providing an inner rotor system that extends at least generally along a first axis, the inner rotor system comprises two or more inner magnets which have alternating positive poles and negative poles; and
seating an outer rotor system over at least a portion of the inner rotor system, the outer rotor system comprises two or more outer magnets which have alternating positive poles and negative poles, wherein at least one of the two or more inner magnets and the two or more outer magnets are separated from each other along lines which are skewed with respect to the first axis and wherein the movement of the outer rotor system with respect to the inner rotor system applies a torque to a device coupled to the inner rotor system.

10. The method as set forth in claim 9 wherein the inner rotor system further comprises providing a shaft which extends along the first axis and has a connection point adjacent one end used for detachably engaging with the device, the two or more inner magnets are connected about at least a portion of the shaft.

11. The method as set forth in claim 10 further comprising separating the two or more outer magnets from each other along the lines which are substantially parallel with respect to the first axis.

12. The method as set forth in claim 10 wherein the lines which separate the two or more outer magnets are skewed with respect to the first axis.

13. The method as set forth in claim 10 wherein the inner rotor system further comprises providing two or more sets of the inner magnets which are spaced along the first axis and wherein the rotatably seating outer rotor system further comprises providing two or more sets of the outer magnets which are spaced along the first axis.

14. The method as set forth in claim 10 further comprising extending a housing around at least a portion of the outer rotor system.

15. A method of applying torque to a device, the method comprising:
detachably coupling an inner rotor system to a device, the inner rotor system extends at least generally along a first axis and comprises two or more inner magnets which have one of a positive pole and a negative pole; and
moving an outer rotor system that is seated over at least a portion of the inner rotor system, the outer rotor system comprises two or more outer magnets which have the other one of the positive pole and the negative pole, wherein at least one of the two or more inner magnets and the two or more outer magnets are separated from each other along lines which are skewed with respect to the first axis and wherein the rotating of the outer rotor system with respect to the inner rotor system applies a torque to the device coupled to the inner rotor system.

16. The method as set forth in claim 15 wherein detachably coupling the inner rotor system to the device further comprises detachably engaging one end of a shaft which extends along the first axis and is in the inner rotor system to the device, the two or more inner magnets are connected about at least a portion of the shaft.

17. The method as set forth in claim 15 wherein the two or more outer magnets are separated from each other along the lines which are substantially parallel with respect to the first axis.

18. The method as set forth in claim 15 wherein the two or more outer magnets are separated from each other along the lines which are skewed with respect to the first axis.

19. The method as set forth in claim 15 wherein the inner rotor system comprises two or more sets of the inner magnets which are spaced along the first axis and wherein the outer rotor system comprises two or more sets of the outer magnets which are spaced along the first axis.

20. The method as set forth in claim 19 further comprising substantially aligning each of the sets of inner magnets with one of the sets of outer magnets.

21. The method as set forth in claim 19 further comprising positioning each of the sets of inner magnets to be at least partially out of alignment with one of the sets of outer magnets.

22. The method as set forth in claim 15 further comprising rotating the outer rotor system with a housing which extends around at least a portion of the outer rotor system.
